(19) United States
(12) Patent Application Publication
(10) Pub. No.: US 2023/0243324 A1
(43) Pub. Date: Aug. 3, 2023

(54) FUEL VALVE

(71) Applicant: Whitecap Industries, Inc., Piscataway, NJ (US)

(72) Inventors: Christopher Brown, Jupiter, FL (US); Todd Moore, St. Paul, MN (US); Christopher E. Tomao, Robbinsville, NJ (US)

(73) Assignee: Whitecap Industries, Inc., Piscataway, NJ (US)

(21) Appl. No.: 17/592,055

(22) Filed: Feb. 3, 2022

(51) Int. Cl. F02M 37/00; F02M 59/46; F16K 15/02; F16K 17/04; F16K 17/06; F16K 17/08

(52) U.S. Cl. CPC F02M 37/0029; F02M 59/46; F16K 15/02; F16K 17/0433; F16K 17/065; F16K 17/082

(57) ABSTRACT

A fuel valve device and a method of controlling fuel flow between a fuel tank and an engine are disclosed. A fuel valve comprises an inlet conduit including an inlet end connectable to a fuel tank and a central axis, an outlet conduit including an outlet end opposite the inlet end connectable to an engine. The outlet conduit has a central axis offset from the inlet conduit central axis. A movable valve ball is configured to block fuel flow from the inlet end to the outlet end at a predetermined pressure and to permit the fuel flow from the inlet end to the outlet end when pressure in the fuel valve device exceeds the predetermined pressure, movable along a travel axis defining an angle with the inlet conduit central axis that is greater than 5 degrees and less than 90 degrees.

### TECHNICAL FIELD

The present disclosure relates generally to fuel valves and methods of controlling fuel flow between a fuel tank and an engine, and in particular, fuel valves that are configured for use in supplying fuel to boats and methods of controlling fuel flow to an engine.

### BACKGROUND

Boats, including pleasure boats, are subject to a variety of federal regulations, including regulations defined in 33 CFR Part 183, which prescribes standards and regulations for boats and associated equipment, including fuel systems. In particular, 33 CFR § 183.568(b) requires each fuel line from the fuel tank to the fuel inlet connection of the engine to have “an anti-siphon device or an electrically operated fuel stop valve” at the fuel tank withdrawal fitting or installed so the line from the fuel tank is above the top of the tank, or meet the requirements in 33 CFR § 183.568(c). As used in the regulations and in this specification, “fuel” refers to all oils of any kind, which may be used to supply power or lubrication for primary or auxiliary purposes onboard the vessel in which it is carried. Therefore, as use herein, fuel includes, but is not limited to gasoline and diesel fuel.

In addition, boats are subject to 40 CFR Part 1060, which pertains to control of evaporative emissions from new and in-use nonroad and stationary equipment. In particular, 40 CFR § 240 (e) (1) requires that “[a] Marine SI fuel tank sealed up to a positive pressure of 7.0 kPa (1.0 psig).” This positive pressure is diurnally induced due to volumetric expansion of fuel within the installed tank. As used in the regulations and herein, “Marine SI” relates to vessels powered by engines that are subject to exhaust and evaporative emission standards in 40 CFR part 1045, which includes boats and pleasure boats.

Simultaneously meeting these anti-siphon and sealed pressure regulations has become a major challenge. In particular, as the regulations pertains to pleasure boat fuel systems that must include a low pressure-actuated <5 PSIG (pounds per square inch gauge) valve that works as a static anti-siphon valve device, and that when vacuum is applied to the outlet, a fuel valve device instantly needs to provide low and high flow, up to as much as 60 gallon per hour (GPH) as demanded by large outboard mounted engines in some cases. A caveat to this components function is the added resistance in fuel flow systems in general that can cause fuel starvation on smaller engines at low revolutions per minute (rpm) when required, such as at idling or trolling speeds used in fishing or bodies of water subject to slow sped (no wake) mandates. Additionally, these same reduced flow rates can cause engine air mixture shortfalls in larger outboard motors, causing a common scenario where there is not sufficient fuel to combust in the appropriate volumetric fuel air mixture in the engine cylinder during the ignition process. This latter scenario is often referred to as “leaning out.”

Typical inline ball and spring actuated valves of the type shown in FIGS. 1A-C have proven to be too restrictive. Diaphragm demand type valves, which have been commonly used in breathing apparatus configurations, have been proposed, in which the valve pushes an actuator to open a needle type valve. This approach, however, has drawbacks for marine fuel system applications in part due to installation constraints and size limitations of pathway geometry, which inherently lead to various fuel turbulence and drag, which in turn increases fuel flow resistance. Moreover, polymer diaphragms used in these harsh marine environments are very susceptible to environmental degradation from UV exposure, cleaning solvents, sea salt, oils, fuels, etc. typically found in boating surroundings.

While existing fuel valve devices have existed for a number of years, the above discussion reveals that existing fuel valve devices have several disadvantages and limitations, and there remains a need for improved fuel valve devices that meet the current regulations and that can address one or more of the limitations discussed above.

### SUMMARY

One or more embodiments of the disclosure are directed to A fuel valve device configured to control fuel flow between a fuel tank and an engine, the fuel valve device comprising an inlet conduit including an inlet end configured for connection to a fuel tank, the inlet conduit having an inlet conduit central axis; an outlet conduit including an outlet end opposite the inlet end in fluid communication with the inlet end and configured for connection to an engine, the outlet conduit having an outlet conduit central axis that is offset from the inlet conduit central axis; and a movable valve ball responsive to a fuel flow from the inlet end, the movable valve ball configured to block fuel flow from the inlet end to the outlet end at a predetermined pressure and to permit the fuel flow from the inlet end to the outlet end when pressure in the fuel valve device exceeds the predetermined pressure, the movable valve ball being movable along a travel axis defining an angle with the inlet conduit central axis that is greater than 5 degrees and less than 90 degrees.

In another aspect, one or more embodiments are directed to a fuel valve device configured to control fuel flow between a fuel tank and an engine, the fuel valve device comprising an inlet conduit including an inlet end configured for connection to a fuel tank, the inlet conduit having an inlet conduit central axis; an outlet conduit including an outlet end opposite the inlet end in fluid communication with the inlet end and configured for connection to an engine, the outlet conduit having an outlet conduit central axis that is offset from the inlet conduit central axis; and a movable valve ball resting on a valve seat and responsive to a fuel flow from the inlet end, the movable valve ball configured to block the fuel flow from the inlet end to the outlet end at a predetermined pressure while resting on the valve seat in a fuel blocking position and configured to travel along a travel axis defining an angle with the inlet conduit central axis that is greater than 5 degrees and less than 90 degrees to permit the fuel flow from the inlet end to the outlet end when pressure in the fuel valve exceeds the predetermined pressure.

Another aspect of the disclosure pertains to a method to control fuel flow between a fuel tank and an engine, the method comprising flowing fuel through a fuel valve device including an inlet conduit including an inlet end configured for connection to a fuel tank, the inlet conduit having an inlet conduit central axis and an outlet conduit including an outlet end opposite the inlet end in fluid communication with the inlet end and configured for connection to an engine, the outlet conduit having an outlet conduit central axis that is offset from the inlet conduit central axis. The method further comprises blocking a fuel flow with a movable valve ball positioned between the inlet end and the outlet end when the movable valve ball is in a blocking position; and permitting the fuel flow when the movable valve ball is displaced along a travel axis that is at an angle with respect to the inlet conduit central axis.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1A is an isometric view of a prior art fuel valve device;

FIG. 1B is a front view of the prior art fuel valve device shown in FIG. 1A;

FIG. 1C is a cross sectional view of the front view of the prior art fuel valve device shown in FIG. 1B;

FIG. 2 is first side, top isometric view of a fuel valve device according to an embodiment of the disclosure;

FIG. 3 is second side, top isometric view of the fuel valve device shown in FIG. 2;

FIG. 4 is a first side, bottom isometric view of fuel the fuel valve device shown in FIG. 2;

FIG. 5 is a top view of the fuel valve device shown in FIG. 2;

FIG. 6 is front view of the fuel valve device shown in FIG. 2;

FIG. 7 is a cross-section view of the fuel valve device shown in FIG. 6;

FIG. 8 is a side perspective view of the fuel valve device shown in FIG. 2 mounted to a fuel tank of a boat according to an embodiment of the disclosure; and

FIG. 9 is a flowchart illustrating a method according to an embodiment of the present disclosure.

### DETAILED DESCRIPTION

Before describing several exemplary embodiments of the disclosure, it is to be understood that the disclosure is not limited to the details of construction or process steps set forth in the following description. The disclosure is capable of other embodiments and of being practiced or being carried out in various ways.

The term “horizontal” as used herein is defined as a plane parallel to the plane or surface of a floor, a deck or a deck of a boat, regardless of its orientation. The term “vertical” refers to a direction perpendicular to the horizontal as just defined. The term “non-horizontal” includes planes that are at 20 degrees to 120 degrees from a horizontal plane, including, but not limited to vertical. Terms, such as “above”, “below”, “bottom”, “top”, “side” (as in “sidewall”), “higher”, “lower”, “upper”, “over”, and “under”, are defined with respect to the horizontal surface as shown in the figures.

The term “on” indicates that there is direct contact between elements. The term “directly on” indicates that there is direct contact between elements with no intervening elements.

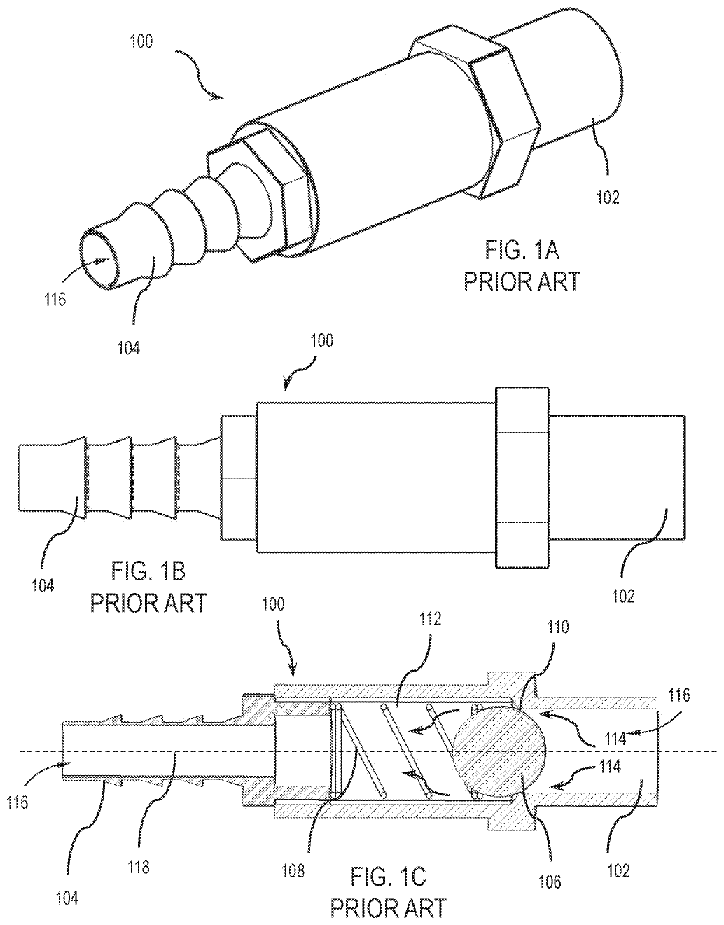

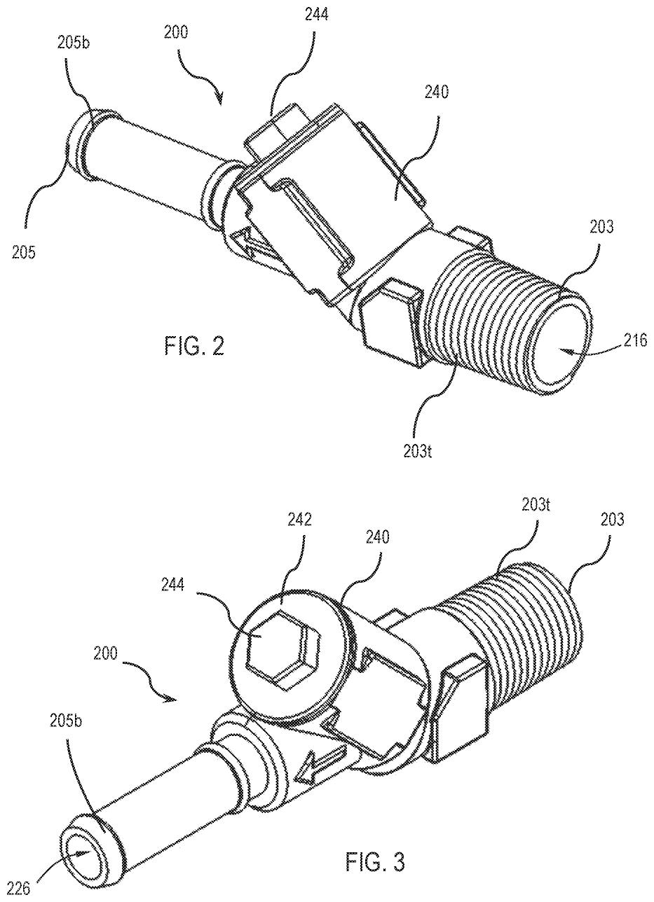

As discussed above, existing fuel valves have several limitations and disadvantages, and they are unable to meet the regulatory requirements and address one more of the issues discussed above. For example, referring to FIGS. 1A-C, show a prior art fuel valve 100, comprising a first end 102 connectable to a fuel tank, a second end 104 connectable to an engine and an intermediate region 112 between the first end 102 and the second end. A fuel conduit 116 extends from the first end 102 to the second end having a central axis. The prior art fuel valve 100, as shown in FIG. 1C includes a valve ball 106 and a compression spring 108 inline with the central axis that causes the valve ball 106, which is seated against valve seat 110 to move into the intermediate region, which has a width that is greater than the diameter of the valve ball 106. When the pressure of fuel 114 (represented by arrows) reaches a predetermined value, the fuel 114, moves the ball valve into the intermediate region 112, the fuel 114 is forced around the outer circumference of the valve ball 106 causing turbulence in fuel flow. As can be seen in FIG. 1C, valve device 100 has the central axis 118 that is common to the first end 102 and the second end 104 of the fuel valve device 100. In other words, the center of the first end 102 is in line with the center of the second end 104, as defined by the central axis 118 that is common to the first end 102 and the second end 104. The turbulent fuel flow is a result of increases in fuel demand at an engine (not shown) connected to the fuel valve as fuel 114 is forced around the valve ball 106 in counteracting the force of the fuel by a compression spring 108 and valve ball 106 arrangement in the prior art.

After careful study of the prior art fuel valve 100 design, it was determined that the prior art fuel valve show in FIGS. 1A-C had several disadvantages. One or more embodiments of the present disclosure provides a fuel valve 200 that is configured to allow fuel to flow in only one direction and hold back greater than 1.00 PSIG fuel from a fuel tank and that is easily displaced as soon as fuel is demanded by an engine fuel pump. In some embodiments, unlike prior art fuel valves 100 of the type shown in FIGS. 1A-C, the spring is not in line with the fuel path, and the spring is instead placed at an obtuse angle behind the valve ball travel operating direction of travel. In some embodiments, due to the valve seat position and the corresponding angle of ball travel upwards and out of the fuel path, fuel is effectively forced to flow under a hemisphere of the valve ball, instead of being forced to flow around the entire valve ball circumference, thereby reducing fluid turbulence behind the ball in the direction of fuel flow, beyond the laminar flow, by at least about 50%. In one or more embodiments, tis reduction in turbulence provides an end result of a reduced curve of energy density, which in turn puts less strain on an outboard motor pump and increases the engine horsepower throughput efficiency. According to certain embodiments, configuring the valve ball so that fuel flowing through valve is forced underneath the ball hemisphere, which causes movement of the valve ball up an obtuse slope versus continually pulling fuel around the valve ball circumference that is directly in line with the fuel flow against the spring also diminishes the energy pushback force needed for the spring to operate.

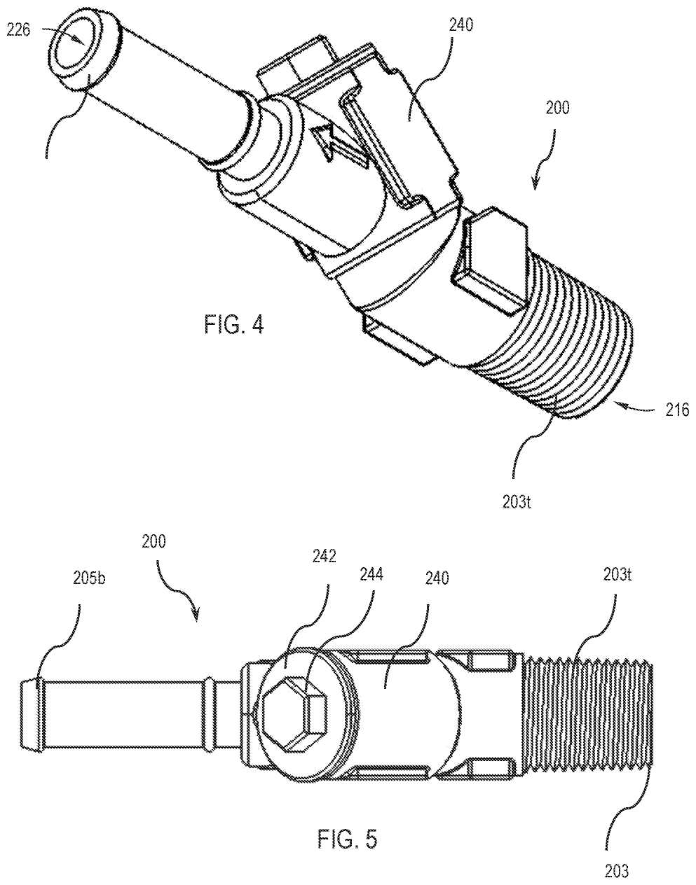

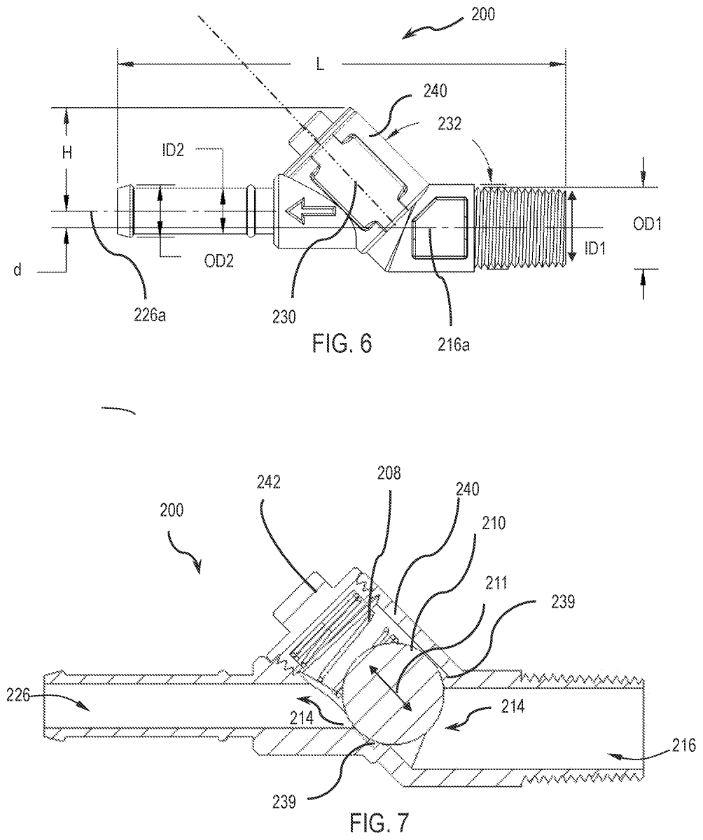

Referring now to FIGS. 2-8, an embodiment of a fuel valve device 200 configured to control fuel flow between a fuel tank 260 and an engine 312 is shown. In some embodiments, the engine may include a fuel pump 310 as part of the engine or upstream from the engine 312 to supply fuel into the engine 312. In the embodiment shown, the fuel valve device 200 comprises an inlet conduit 216 including an inlet end 203 configured for connection to the fuel tank 260, the inlet conduit 216 having an inlet conduit central axis 216a at the center of the inlet conduit 216. The fuel valve device 200 further comprises an outlet conduit 226 including an outlet end 205 opposite the inlet end 203 in fluid communication with the inlet end 203 and configured for connection to an engine 312, the outlet conduit 226 having an outlet conduit central axis 226a that is offset from the inlet conduit central axis 216a. The inlet conduit 216 and the outlet conduit 226 together define a fuel conduit through which fuel flows from the inlet end 203 to the outlet end 205. As used herein, “offset” refers to two axes that are not aligned with each other. For example, as shown in FIG. 6, inlet conduit central axis 216a and the outlet conduit central axis 226a are not aligned with each other, but instead separated by a distance “d” (or offset by distance “d”) from each other. In one of more embodiments the distance “d” which the inlet conduit central axis 216a and the outlet conduit central axis 226a are offset from each other is in a range of from 0.05 inches to 0.3 inches, for example, 0.1 inches, 0.12 inches, 0.14 inches, 0.16 inches, 0.2 inches, 0.25 inches or 0.28 inches. These distances “d” are exemplary and not limiting.

The exemplary embodiment of the fuel valve device 200 further comprises a movable valve ball 210 configured to be moved in response to a flow of fuel 214 from the inlet end 203. The movable valve ball is further configured to block fuel 214 flowing from the inlet end 203 to the outlet end 205 at a predetermined pressure and to permit the fuel 214 flow from the inlet end 203 to the outlet end 205 when pressure in the fuel valve device 200 exceeds the predetermined pressure. The movable valve ball 210 is movable along a travel axis 230 defining an angle 232 that is obtuse with the inlet conduit central axis 216a that is greater than 90 degrees and less than 175 degrees. It will be understood that this range of angles is exemplary only, and other ranges are within the scope of the disclosure. For example, the angle 232 in some embodiments is greater than 90 degrees and less than 170, 165, 160, 155, 150, 145, 140, 135, 130, 125, 120, 115 or 110 degrees. In one or more embodiments the angle is in a range of from 115 degrees to 150 degrees, 115-145 degrees, 115-140 degrees, 120-150 degrees, 120-145 degrees, 120-140 degrees, 125-150 degrees, 120-145 degrees, 120-140 degrees, 130-150 degrees, 130-145 degrees, or 130-140 degrees, for example 135 degrees.

In some embodiments, the travel axis 230 defines the angle 232 with the inlet conduit central axis 216a that is greater than 100 degrees and less than 170 degrees. In other embodiments, the travel axis 230 defines the angle 232 with the inlet conduit central axis 216a that is greater than 110 degrees and less than 165 degrees.

The travel axis 230 of movable valve ball 210 is defined by a valve housing 240 which contains the movable valve ball 210 and is at an angle to the inlet conduit 216 and the outlet conduit 226. The valve housing further contains a spring 208 engaged with the movable valve ball 210, which is movable in the direction of arrow 211 along the travel axis 230, wherein the spring 208 and the movable valve ball 210 are movably disposed in the valve housing 240. The valve housing may further comprise a cap 242 which can include a fitting 244 to permit removal of the cap 242 to permit cleaning, servicing and/or replacement of the spring 208 and/or the movable valve ball 210.

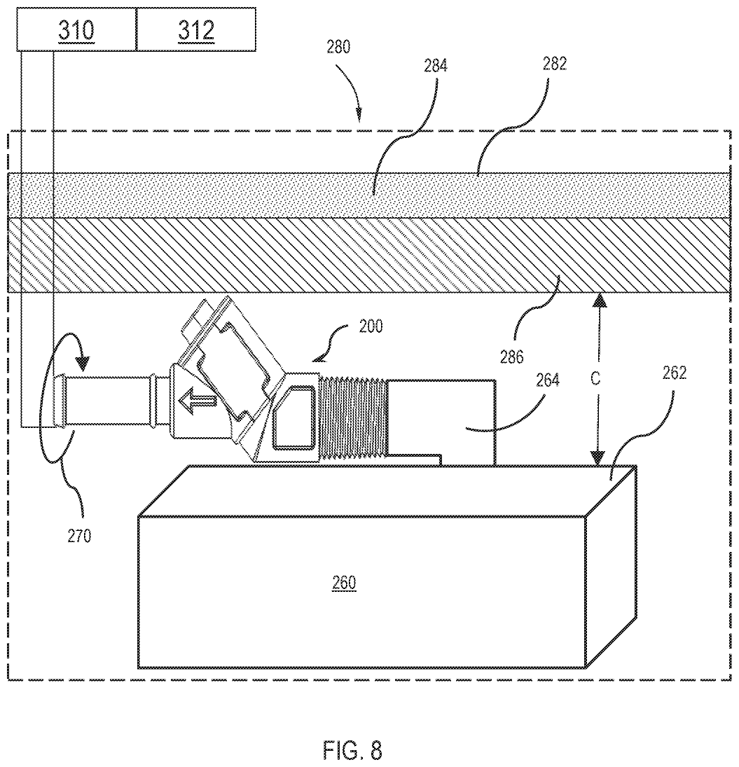

Referring now to FIG. 8, which is a side perspective view of the fuel valve device 200 mounted to a fuel tank 260 of a boat 280, which is only a partial view of the deck 282 of a boat, which typically comprises a first layer 284 (e.g., fiberglass) over a substrate 286 (e.g., plywood or other wood). The distance between substrate 286 and a top surface 262 of the fuel tank is shown as “C” in FIG. 8. This distance “C” is finite and determined by United States Coast Guard regulations and American Boat and Yacht Council standards and accommodates an outside diameter of a fuel filling hose combined with a fuel hose worm gear clamps. This distance “C” is 2.00 inches. To meet these installation distance constraints, the manufacturing tolerances of the fuel valve device 200 were precisely selected and controlled to accommodate threading the fuel valve device 200 onto a threaded fitting 264 of the fuel tank 260. Threading the fuel valve device 200 is accomplished by turning the fuel valve device in the direction of arrow 270. As will be appreciated, threading of the fuel valve device 200 onto the fitting 264 will result in a swing diameter defined by the outermost dimensions to allow installation on to the top of a marine fuel tank top surface.

Additionally, according to one or more embodiments described herein, the fuel valve device 200 maximizes the fuel flow between the inlet end 203 and the outlet end 205 in the fuel path cavity defined by the inlet conduit 216 outer diameter OD1, wall thickness and inner diameter and the outlet conduit 226 inner diameter ID2 to minimize fuel flow restriction through the fuel valve device 200. The dimensions of the fuel valve device 200 takes into account fixed manufacturing standard dimensions of both ⅜ inch and ½ inch hose which are fit over outlet end 205 barbed outlet end 205b and ⅜ inch Male National Pipe Thread (MNPT) on the inlet end 203 threads to provide a threaded fitting 203t, which are standard sizes in boats and yachts. In one or more embodiments, a thin wall thickness is provided for the fuel valve device 200. According to one or more embodiments, embodiments of the fuel valve device 200 provided herein are configured to be retrofitted into existing boats and yachts already placed in service. As used herein, the term “boat” includes both boats and yachts, with yachts being larger recreational boats. In exemplary embodiments, the fuel valve device 200 has an OD1 at the inlet end 203 of 0.67 inches, a length L of 3.67 inches, an OD2 at the outlet end 205 of 0.43 inches, an ID2 of 0.38 inches, and a wall thickness of 0.0.05 inches. The fuel valve device of some embodiments has a height H measured from the outlet conduit central axis 226a to the top surface on the valve housing 240 is 0.85 inches. This height H provides adequate swing diameter during installation to meet the required clearance between the substrate 286 of the deck and the top surface 262 of the fuel tank 260. These dimensions are non-limiting, exemplary values.

In one or more embodiments, the fuel valve device 200 is sized to have a maximum height H from the outlet conduit central axis 226a to the top surface of the valve housing 240 so that when the fuel valve device is rotated about the inlet conduit central axis, the fuel valve device defines a rotational radius about the inlet conduit central axis that is less than 1 inch, less than or equal to 0.95 inches, 0.90 inches or 0.85 inches. In one or more embodiments, the fuel valve device 200 is configured so that fuel flows from the inlet end 203 to the outlet end 205, and the fuel 214 does not encircle or completely surround the entire circumference of the movable valve ball 210 during and after the movable valve ball 210 travels along the travel axis 230 to an open position. As used herein, a “closed position” refers to the position shown in FIG. 7 in which the valve ball is in contact with the valve seat 239. As a person of ordinary skill in the art will understand, in the closed position shown in FIG. 7, fuel 214 does not flow past the movable valve ball 210. In the closed position, the force exerted by the spring 208 is greater than any force applied to the movable valve ball such that the movable valve ball 210 remains seated against the valve seat 239 and does not allow fuel to flow into the outlet conduit 226.

In an open position, vapor and fluid pressure has been exerted against the movable valve ball that is sufficient to exert a force on the movable valve ball 210 to cause the movable valve ball 210 to overcome the force exerted by the spring 208 which pushes the movable valve ball 210 away from the valve seat, compressing the spring 208 and moving the movable valve ball further into the valve housing 240 closer to the lid 242, allowing fuel 214 to flow underneath the movable valve ball 210, but not around the entire circumference of the movable valve ball 210. The movable valve ball moves in the directions of the arrow 211 when moving between the open position and the closed position.

The fuel valve device 200 is configured so that fuel 214 flows from the inlet end 203 to the outlet end 205 and underneath the movable valve ball 210 as the movable valve ball travels along the travel axis 230. In some embodiments, the inlet conduit 203 has an internal diameter ID1 defining a fuel bore through which fuel flows, and the movable valve ball 210 is configured to open and close the fuel bore and maintain a minimum 0.500″ fuel bore opening when the movable valve ball 210 is in an open position. In the closed position, the fuel valve device 200 is configured to so that the movable valve ball 210 remains in a closed position blocking the fuel bore to prevent flow therethrough there is a fluid pressure in the fuel bore that is less than 1.00 PSIG.

In another embodiment, a fuel valve device configured to control fuel flow between a fuel tank 260 and an engine 312 comprises the inlet conduit 216 including an inlet end 203 configured for connection to the fuel tank 260, an outlet conduit 226 including an outlet end 205 opposite the inlet end 203 in fluid communication with the inlet end 203 and configured for connection to the engine 312, the outlet conduit 226 having an outlet conduit central axis 226a that is offset from the inlet conduit central axis 216a. The fuel valve device 200 includes a movable valve ball 210 resting on a valve seat 239 and configured to be moved in response to a flow of fuel 214 from the inlet end 203, the movable valve ball 210 configured to block the fuel flow from the inlet end 203 to the outlet end 205 at a predetermined pressure while resting on the valve seat 239 in a fuel blocking position and configured to travel along a travel axis 230 defining an angle with the inlet conduit central axis that is greater than 90 degrees and less than 175 degrees to permit the fuel flow from the inlet end to the outlet end when pressure in the fuel valve exceeds the predetermined pressure. In one or more embodiments, the fuel valve device 200 is configured so that fuel 214 flows from the inlet end 203 to the outlet end 205, and the fuel 214 does not encircle the entire circumference the movable valve ball 210 during and after the movable valve ball 210 travels along the travel axis 230 to an open position in which the fuel 214 is permitted to flow to the outlet conduit 226.

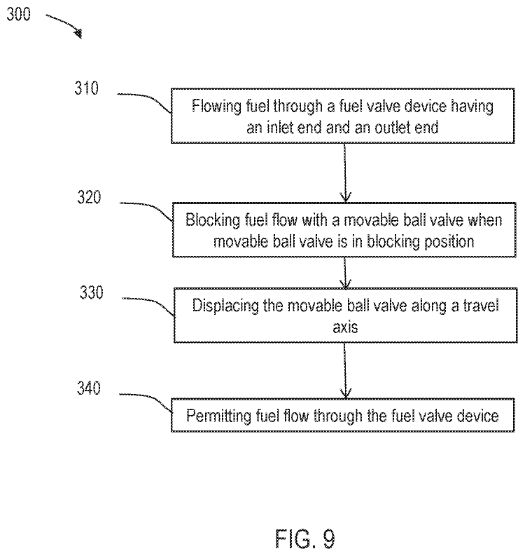

Referring to FIG. 9, a method 300 to control fuel flow between a fuel tank and an engine using the fuel valve device 200 shown and described herein comprises at 310 flowing fuel through a fuel valve device 200 including an inlet conduit 216 including an inlet end 203 configured for connection to a fuel tank 260, the inlet conduit 216 having an inlet conduit central axis 216a and an outlet conduit 226 including an outlet end 205 opposite the inlet end 203 in fluid communication with the inlet end 203 and configured for connection to an engine 312, the outlet conduit 226 having an outlet conduit central axis 226a that is offset from the inlet conduit central axis 216a. The method further comprises at 320 blocking a fuel flow with a movable valve ball 210 positioned between the inlet end 203 and the outlet end 205 when the movable valve ball 210 is in a blocking position. The method continues at 330 by permitting the fuel flow when the movable valve ball 210 is displaced along a travel axis 230 that is at an angle 232 that is obtuse with respect to the inlet conduit central axis 216a.

In embodiments of the method, the fuel valve device 200 further comprises a spring 208 disposed in a valve housing 240. The method 300 may further include forcing a flow of fuel through to the outlet end wherein fuel does not encircle the entire circumference of the movable valve ball 210, but instead the fuel flows only along an underside of the movable valve ball 210. In embodiments, the fuel valve device 200 is sized to have a maximum height so that when the fuel valve device 200 is rotated about the inlet conduit central axis 216a, the fuel valve device defines a rotational radius about the inlet conduit central axis that is less than 1 inch. In embodiments of the method 300, the inlet conduit 216 has an internal diameter defining a fuel bore through which fuel flows, and the movable valve ball 210 is configured to open and close the fuel bore and maintain a minimum 0.500 inch fuel bore opening when the movable valve ball 210 is in an open position.

Although embodiments of the present disclosure have been described in detail hereinabove in connection with certain exemplary embodiments, it should be understood that the disclosure is not limited to the disclosed exemplary embodiments, but is intended to cover various modifications and/or equivalent arrangements included within the spirit and scope of the present disclosure.

Reference throughout this specification to “one embodiment,” “certain embodiments,” “one or more embodiments” or “an embodiment” means that a particular feature, structure, material, or characteristic described in connection with the embodiment is included in at least one embodiment of the disclosure. Thus, the appearances of the phrases such as “in one or more embodiments,” “in certain embodiments,” “in one embodiment” or “in an embodiment” in various places throughout this specification are not necessarily referring to the same embodiment of the disclosure. Furthermore, the particular features, structures, materials, or characteristics may be combined in any suitable manner in one or more embodiments.

Although the disclosure herein has been described with reference to particular embodiments, it is to be understood that these embodiments are merely illustrative of the principles and applications of the present disclosure. It will be apparent to those skilled in the art that various modifications and variations can be made to the method and apparatus of the present disclosure without departing from the spirit and scope of the disclosure. Thus, it is intended that the present disclosure include modifications and variations that are within the scope of the appended claims and their equivalents.

What is claimed is:

1. A fuel valve device configured to control fuel flow between a fuel tank and an engine, the fuel valve device comprising:
an inlet conduit including an inlet end configured for connection to the fuel tank, the inlet conduit having an inlet conduit central axis;
an outlet conduit including an outlet end opposite the inlet end in fluid communication with the inlet end and configured for connection to an engine, the outlet conduit having an outlet conduit central axis that is offset from the inlet conduit central axis; and
a movable valve ball configured to be moved in response to a flow of fuel from the inlet end, the movable valve ball configured to block fuel flow from the inlet end to the outlet end at a predetermined pressure and to permit the fuel flow from the inlet end to the outlet end when pressure in the fuel valve device exceeds the predetermined pressure, the movable valve ball being movable along a travel axis defining an angle with the inlet conduit central axis that is greater than 90 degrees and less than 175 degrees.

2. The fuel valve device of claim 1, wherein the travel axis defines the angle with the inlet conduit central axis that is greater than greater than 100 degrees and less than 170 degrees.

3. The fuel valve device of claim 1, wherein the travel axis defines the angle with the inlet conduit central axis that is greater than 110 degrees and less than 165 degrees.

4. The fuel valve device of claim 1, further comprising:
a valve housing; and
a spring, wherein the spring and the movable valve ball are movably disposed in the valve housing.

5. The fuel valve device of claim 4, wherein the fuel valve device is sized to have a maximum height so that when the fuel valve device is rotated about the inlet conduit central axis, the fuel valve device defines a rotational radius about the inlet conduit central axis that is less than or equal to 1 inch.

6. The fuel valve device of claim 5, wherein the fuel valve device is configured so that fuel flows from the inlet end to the outlet end, and the fuel does not encircle the movable valve ball during and after the movable valve ball travels along the travel axis to an open position.

7. The fuel valve device of claim 5, wherein the fuel valve device is configured so that fuel flows from the inlet end to the outlet end and underneath the movable valve ball as the movable valve ball travels along the travel axis.

8. The fuel valve device of claim 1, wherein the inlet conduit has an internal diameter defining a fuel bore through which fuel flows, and the movable valve ball is configured to open and close the fuel bore and maintain a minimum 0.500″ fuel bore opening when the movable valve ball is in an open position.

9. The fuel valve device of claim 8, wherein the fuel valve device is configured to so that the movable valve ball remains in a closed position blocking the fuel bore to prevent flow therethrough there is a fluid pressure in the fuel bore that is less than 1.00 pounds per square inch gauge (PSIG).

10. The fuel valve device of claim 1, wherein the outlet end comprises a barbed outlet and the inlet end comprises a threaded fitting.

11. A fuel valve device configured to control fuel flow between a fuel tank and an engine, the fuel valve device comprising:
an inlet conduit including an inlet end configured for connection to the fuel tank, the inlet conduit having an inlet conduit central axis;
an outlet conduit including an outlet end opposite the inlet end in fluid communication with the inlet end and configured for connection to an engine, the outlet conduit having an outlet conduit central axis that is offset from the inlet conduit central axis; and
a movable valve ball resting on a valve seat and configured to be moved in response to a flow of fuel from the inlet end, the movable valve ball configured to block the fuel flow from the inlet end to the outlet end at a predetermined pressure while resting on the valve seat in a fuel blocking position and configured to travel along a travel axis defining an angle with the inlet conduit central axis that is greater than 5 degrees and less than 90 degrees to permit the fuel flow from the inlet end to the outlet end when pressure in the fuel valve exceeds the predetermined pressure.

12. The fuel valve device of claim 11, further comprising:
a valve housing; and
a spring and the movable valve ball movably disposed in the valve housing, wherein the spring exerts a force against the movable valve ball to place the movable valve ball to the fuel blocking position.

13. The fuel valve device of claim 12, the movable valve ball being movable along a travel axis defining an angle with the inlet conduit central axis that is greater than 15 degrees and less than 70 degrees.

14. The fuel valve device of claim 12, wherein the fuel valve device is configured so that fuel flows from the inlet end to the outlet end, and the fuel does not encircle the movable valve ball during and after the movable valve ball travels along the travel axis to an open position in which fuel is permitted to flow to the outlet conduit.

15. A method to control fuel flow between a fuel tank and an engine, the method comprising:
flowing fuel through a fuel valve device including an inlet conduit including an inlet end configured for connection to a fuel tank, the inlet conduit having an inlet conduit central axis and an outlet conduit including an outlet end opposite the inlet end in fluid communication with the inlet end and configured for connection to an engine, the outlet conduit having an outlet conduit central axis that is offset from the inlet conduit central axis;
blocking a fuel flow with a movable valve ball positioned between the inlet end and the outlet end when the movable valve ball is in a blocking position; and
permitting the fuel flow when the movable valve ball is displaced along a travel axis that is at an angle with respect to the inlet conduit central axis.

16. The method of claim 15, wherein the fuel valve device further comprises a spring disposed in a valve housing.

17. The method of claim 16, further comprising forcing a flow of fuel through to the outlet end wherein fuel does not encircle the movable valve ball.

18. The method of claim 17, wherein the fuel flows only along an underside of the movable valve ball.

19. The method of claim 15, wherein the fuel valve device is sized to have a maximum height so that when the fuel valve device is rotated about the inlet conduit central axis, the fuel valve device defines a rotational radius about the inlet conduit central axis that is less than 1 inch.

20. The method of claim 15, wherein the inlet conduit has an internal diameter defining a fuel bore through which fuel flows, and the movable valve ball is configured to open and close the fuel bore and maintain a minimum 0.500 inch fuel bore opening when the movable valve ball is in an open position.
